(19) United States
(12) Patent Application Publication
(10) Pub. No.: US 2018/0128930 A1
(43) Pub. Date: May 10, 2018

(54) Apparatus and Method for Nonlinear Acoustic Self-demodulation for Cased Hole Cement Evaluation Measurement

(71) Applicant: GOWell International, LLC, Houston, TX (US)

(72) Inventors: Jinsong Zhao, Houston, TX (US); Qinshan Yang, Katy, TX (US)

(73) Assignee: GOWell International, LLC, Houston, TX (US)

(21) Appl. No.: 15/346,362

(22) Filed: Nov. 8, 2016

(51) Int. Cl. G01V 1/50; E21B 47/00; E21B 47/14

(52) U.S. Cl. CPC G01V 1/50; E21B 47/14; E21B 47/0005

(57) ABSTRACT

A method and system for inspecting concrete downhole. The method may comprise inserting an inspection device inside a tube. The inspection device may comprise a sensor array which may comprise a high frequency transmitter, a low frequency transmitter, and a mid frequency receiver. The inspection device may further comprise a micro controller unit, a telemetry module, and a centralizing module. The method may further comprise activating the low frequency transmitter, recording reflections of acoustic waves off a tubing or a casing, and creating a graph with an information handling system for analysis. An inspection device may comprise a sensor array which may comprise a high frequency transmitter and a mid frequency receiver. The inspection device may further comprise a sensor array housing, an information handling system, a memory module, and a differential amplifier.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

### Field of the Disclosure

This disclosure relates to a field for a downhole tool that may be capable of detecting in cement, bad interfaces between casing and cement, and/or bad interfaces between cement and a formation. Processing recorded non-linear acoustic waves from a sensor array may help identify properties within tubing, casing, cement, and/or a formation.

### Background of the Disclosure

Tubing may be used in many different applications and may transport many types of fluids. Tubes may be conventionally placed underground and/or positioned in an inaccessible area, making inspection of changes within tubing difficult. Additionally, tubing may be surround and/or encased by a casing and/or cement. It may be beneficial to measure the thickness of the surrounding cement and/or the interface between the casing and the cement. Previous methods for inspecting cement have come in the form of non-destructive inspection tools that may transmit linear acoustic waves that may be reflected and recorded for analysis. Previous methods may not be able to perform measurements of the interface between casing and cement. Without limitation, different types of transmitters may be utilized in an inspection tool. A single sensor array may be well suited for multiple types of inspection because it may operate and may be insensitive to any fluid within the tube and may use a single tool for a plurality of measurements.

Previous devices and methods may only measure linear acoustic waves and may only be useful for the detection of cement to casing adhesion. Linear acoustic wave measurements may be hindered by the type of tube, thinning of tubing, type of cement, and/or the solidification of the cement.

Consequently, there is a need for an inspection device and methods that may be able to detect and record multiple types of information and/or properties of tubing and cement to determine deterioration in tubing, cement adhesion, and/or the cement itself. In downhole applications, an inspection device with multi-frequency detection may be capable of determining properties of tubing, cement, properties of cement, and the adhesion between casing and cement may be in high demand.

### BRIEF SUMMARY OF SOME OF THE PREFERRED EMBODIMENTS

These and other needs in the art may be addressed in embodiments by a method for processing measurements recorded by an inspection device.

A method for inspecting concrete downhole may comprise inserting an inspection device inside a tube. The inspection device may comprise a sensor array which may further comprise a high frequency transmitter, a low frequency transmitter, and a mid frequency receiver. The inspection device may further comprise a micro controller unit, a telemetry module, and a centralizing module. The method may further comprise activating the low frequency transmitter, wherein the low frequency transmitter produces a non-linear wave, recording reflections of acoustic waves off a tubing or a casing, and creating a graph with an information handling system for analysis.

A method for inspecting concrete downhole may comprise inserting an inspection device inside a tube. The inspection device may comprise a sensor array that may further comprise a first high frequency transmitter, a second high frequency transmitter, and a mid frequency receiver. The inspection device may further comprise a micro controller unit, a telemetry module, and a centralizing module. The method may further comprise activating the first high frequency transmitter and the second high frequency transmitter, wherein a non-linear wave is broadcasted by destructive interference from the first high frequency transmitter and the second high frequency transmitter, recording reflections of acoustic waves off a tubing or a casing, and creating a graph with an information handling system for analysis.

An inspection device may comprise a sensor array which may comprise a high frequency transmitter and a mid frequency receiver. The inspection device may further comprise a sensor array housing, wherein the sensor array is disposed within the sensor array housing, an information handling system, a memory module, and a differential amplifier.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates an embodiment of an inspection system disposed downhole;

FIG. 2 illustrates an embodiment of a sensor array;

FIG. 3 illustrates a graph of a phenomenological model of hysteresis in cement;

FIG. 4 illustrates a graph of open and closed states;

FIG. 5 illustrates a graph of a bad casing and cement interface;

FIG. 6 illustrates a graph of a good casing and cement interface;

FIG. 7 illustrates a graph of potential defects inside cement;

FIG. 8 illustrates an embodiment of a low frequency wave created by two high frequency transmitters; and

FIG. 9 illustrates a filter being applied to recorded non-linear acoustic waves.

### DETAILED DESCRIPTION OF THE PREFERRED EMBODIMENTS

The present disclosure relates to embodiments of a device and method for inspecting and detecting properties of concrete attached to casing. More particularly, embodiments of a device and method are disclosed for inspecting any number of concrete walls surrounding an innermost tubing. In embodiments, an inspection device may transmit acoustic waves in surrounding casing and concrete which may reflect the acoustic waves for recording. The recorded acoustic waves may be analyzed for aberrations and/or properties of the concrete. Acoustic waves may be produced by a sensor array, which may be switched on and off to produce and record acoustic waves in a casing and/or surrounding concrete walls. The acoustic wave diffusion and/or reflection in the casing and/or surrounding concrete may be recorded, specifically nonlinear acoustic waves, which may be processed to determine the location of aberrations within the concrete, which may comprise inadequate tubing and concrete adhesion, inadequate concrete and formation adhesion, cracks in the concrete, and/or the like.

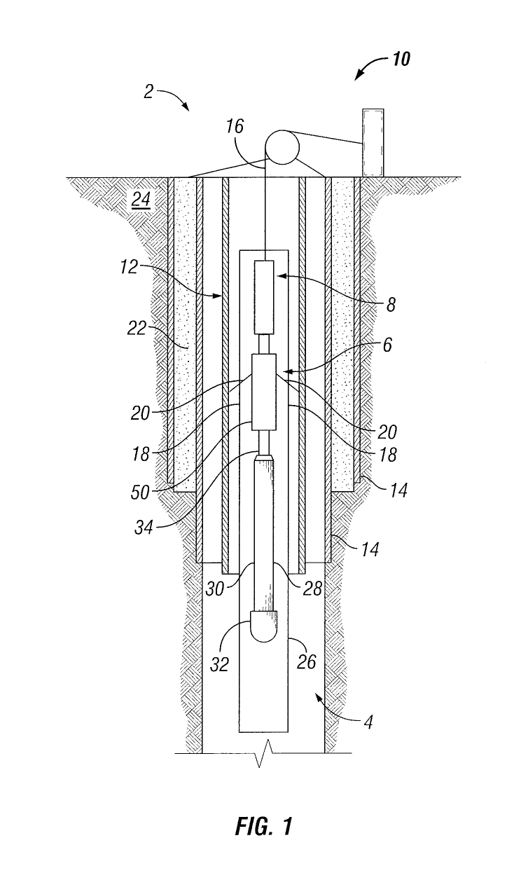

FIG. 1 illustrates an inspection system 2 comprising an inspection device 4, a centralizing module 6, a telemetry module 8, and a service device 10. In embodiments, inspection device 4 may be inserted into tubing 12, wherein tubing 12 may be contained within casing 14. In further embodiments, there may be a plurality of casing 14, wherein tubing 12 may be contained by several additional casings 14. In embodiments, as shown, inspection device 4 may be disposed below centralizing module 6 and telemetry module 8. In other embodiments, not illustrated, inspection device 4 may be disposed above and/or between centralizing module 6 and telemetry module 8. In embodiments, inspection device 4, centralizing module 6, and telemetry module 8 may be connected to tether 16. Tether 16 may be any suitable cable that may support inspection device 4, centralizing module 6, and telemetry module 8. A suitable cable may be steel wire, steel chain, braided wire, metal conduit, plastic conduit, ceramic conduit, and/or the like. A communication line, not illustrated, may be disposed within tether 16 and connect inspection device 4, centralizing module 6, and telemetry module 8 with service device 10. Without limitation, inspection system 2 may allow operators on the surface to review recorded data in real time from inspection device 4, centralizing module 6, and telemetry module 8.

As illustrated in FIG. 1, service device 10 may comprise a mobile platform (i.e. a truck) or stationary platform (i.e. a rig), which may be used to lower and raise inspection system 2. In embodiments, service device 10 may be attached to inspection system 2 by tether 16. Service device 10 may comprise any suitable equipment which may lower and/or raise inspection system 2 at a set or variable speed, which may be chosen by an operator. The movement of inspection system 2 may be monitored and recorded by telemetry module 8.

Telemetry module 8, as illustrated in FIG. 1, may comprise any devices and processes for making, collecting, and/or transmitting measurements. For instance, telemetry module 8 may comprise an accelerator, gyro, and the like. In embodiments, telemetry module 8 may operate to indicate where inspection system 2 may be disposed within tubing 12 and the orientation of sensor array 32, discussed below. Telemetry module 8 may be disposed at any location above, below, and/or between centralizing module 6 and inspection device 4. In embodiments, telemetry module 8 may send information through the communication line in tether 16 to a remote location such as a receiver or an operator in real time, which may allow an operator to know where inspection system 2 may be located within tubing 12. In embodiments, telemetry module 8 may be centered about laterally in tubing 12.

As illustrated in FIG. 1, centralizing module 6 may be used to position inspection device 4 and/or telemetry module 8 inside tubing 12. In embodiments, centralizing module 6 laterally positions inspection device 4 and/or telemetry module 8 at about a center of tubing 12. Centralizing module 6 may be disposed at any location above and/or below telemetry module 8 and/or inspection device 4. In embodiments, centralizing module 6 may be disposed above inspection device 4 and below telemetry module 8. Centralizing module 6 may comprise arms 18. In embodiments, there may be a plurality of arms 18 that may be disposed at any location along the exterior of centralizing module 6. Specifically, arms 18 may be disposed on the exterior of centralizing module 6. In an embodiment, as shown, at least one arm 18 may be disposed on opposing lateral sides of centralizing module 6. Additionally, there may be at least three arms 18 disposed on the outside of centralizing module 6. Aims 18 may be moveable at about the connection with centralizing module 6, which may allow the body of arm 18 to be moved closer and/or farther away from centralizing module 6. Arms 18 may comprise any suitable material. Suitable material may be but is not limited to, stainless steel, titanium, metal, plastic, rubber, neoprene, and/or any combination thereof. In embodiments, centralizing module 6 may further comprise springs 20. Springs 20 may assist arms 18 in moving centralizing module 6 away from tubing 12, and thus inspection device 4 and telemetry module 8, to about the lateral center of tubing 12.

Inspection device 4, as illustrated in FIG. 1, may be able to determine the location of aberrations within concrete 22, which may comprise inadequate tubing 12 and concrete 22 adhesion, inadequate concrete 22 and formation 24 adhesion, cracks in concrete 22, and/or the like. In embodiments, inspection device 4 may be able to detect, locate transverse and longitudinal defects (both internal and external) and/or, determine the deviation of the wall thickness from its nominal value thorough the interpretation of recorded acoustic waves. Tubing 12 may be made of any suitable material for use in a wellbore. Suitable material may be, but is not limited to, metal, plastic, and/or any combination thereof. Additionally, any type of fluid may be contained within tubing 12 such as, without limitation, water, hydrocarbons, and the like. In embodiments, there may be additional casing 14 which may encompass tubing 12. Inspection device 4 may comprise a housing 26 in which a memory module 28, a sensor array controller 30, sensor array 32, centralizing module 6, telemetry module 8, and/or the like may be disposed. Without limitation, sensor array 32 may be disposed at any location within inspection device 4. Housing 26 may be any suitable length in which to protect and house the components of inspection device 4. In embodiments, housing 26 may be made of any suitable material to resist corrosion and/or deterioration from a fluid. Suitable material may be, but is not limited to, titanium, stainless steel, plastic, and/or any combination thereof. Housing 26 may be any suitable length in which to properly house the components of inspection device 4. A suitable length may be about one foot to about ten feet, about four feet to about eight feet, about five feet to about eight feet, or about three feet to about six feet. Additionally, housing 26 may have any suitable width. The width may include a diameter from about one foot to about three feet, about one inch to about three inches, about three inches to about six inches, about four inches to about eight inches, about six inches to about one foot, or about six inches to about two feet. Housing 26 may protect memory module 28, sensor array controller 30, and/or the like from the surrounding downhole environment within tubing 12.

As illustrated in FIG. 1, memory module 28 may be disposed within inspection device 4. In embodiments, memory module 28 may store all received, recorded and measured data and may transmit the data in real time through a communication line in tether 16 to a remote location such as an operator on the surface. Memory module 28 may comprise flash chips and/or ram chips, which may be used to store data and/or buffer data communication. Additionally, memory module 28 may further comprise a transmitter, processing unit and/or a microcontroller. In embodiments, memory module 28 may be removed from inspection device 4 for further processing. Memory module 28 may be disposed within any suitable location of housing 26 such as about the top, about the bottom, or about the center of housing 26. In embodiments, memory module 28 may be in communication with sensor array controller 30 and sensor array 32 by any suitable means such as a communication line 34. In embodiment, an information handling system 50, discussed in further detail below, may be disposed in inspection device 4 an communicate with memory module 28 through tether 16. Information handling system 50 may analyze recorded acoustic waves to determine properties of tubing 12, casing 14, concrete 22, and/or formation 24. In embodiments, information handling system 50 may be disposed within inspection device 4 and may transmit information through tether 16 to service device 10.

Sensor array controller 30, as illustrated in FIG. 1, may control acoustic waves transmitted from sensor array 32. Sensor array controller 30 may be pre-configured at the surface to take into account the downhole logging environment and specific logging cases, which may be defined as a static configuration. It may also be dynamically configured by what sensor array 32 may record. Sensor array controller 30 may be disposed at any suitable location within housing 26. In embodiments, such disposition may be about the top, about the bottom, or about the center of housing 26.

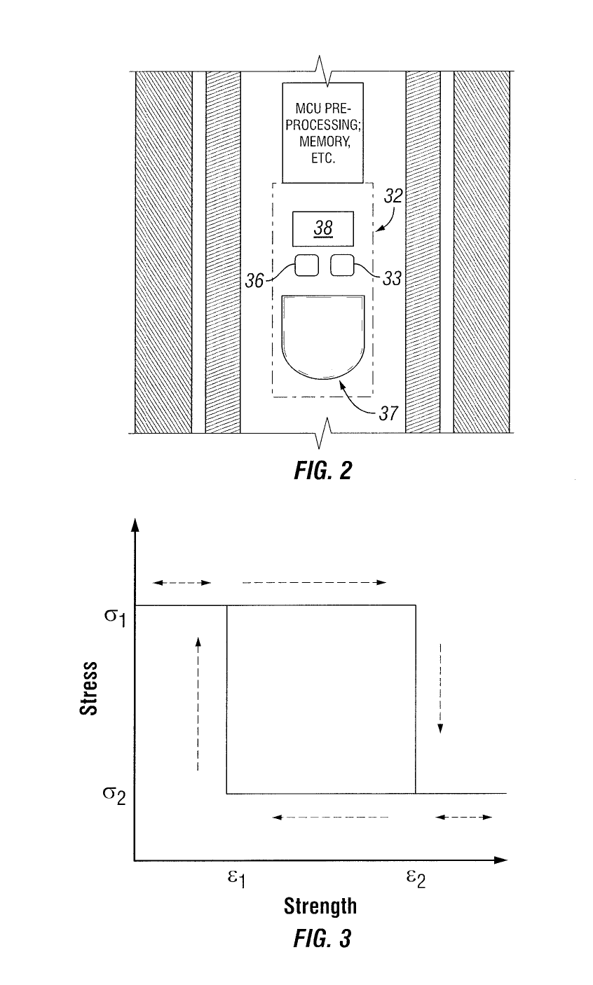

As illustrated in FIGS. 1 and 2, sensor array 32 may create a non-linear acoustic wave, which may be directed into surrounding tubing 12 and/or casing 14. Without limitation, the non-linear acoustic wave may further be generated by a parametric emitting antenna matrix, a parametric receiving antenna matrix, an electrical magnetic pulse, a structure that may move casing 14, transient change to thermal environment, transient change to fluid flow rate or fluid pressure, and/or the like. The acoustic wave that may be transmitted back from tubing 12 and/or casing 14 may be sensed and recorded by sensor array 32. In embodiments, the recorded acoustic wave may allow identification of the properties of tubing 12 and/or casing 14, discussed below. It should be noted that properties of a plurality of casing 14, outside tubing 12, and cement 22 between each of the plurality of casing 14 may be determined from the recorded acoustic wave. Sensor array 32 may be disposed at any suitable location within housing 26, referring to FIG. 1. Such disposition may be at about the top, about the bottom, or about the center of housing 26. Additionally, there may be a plurality of sensor arrays 32 disposed throughout housing 26.

As illustrated in FIG. 2, sensor array 32 may comprise a low frequency transmitter 37, a high frequency transmitter 36, and/or a middle frequency receiver 38. Without limitation, low frequency transmitter 37 may broadcast at about 100 Hz to about 5 kHz. High frequency transmitter 36 may broadcast at about 5 kHz to about 200 kHz. Low frequency transmitter 37 may be a single device and/or multiple middle frequency transmitters (not illustrated) that may generate low frequency through self-modulation. Middle frequency transmitters (not illustrated) may broadcast at about 5 kHz to about 200 kHz. High frequency transmitter 36 may be a single device which may be rotated by a motor, not illustrated, which may turn high frequency transmitter 36 in any direction. In embodiments, the motor may be replace by a multitude of high frequency transmitters 36, which may face different directions. Middle frequency receiver 38 may sense signals within a frequency range from about 5 kHz to about 200 kHz. Middle frequency receiver 38 may comprise a plurality of middle frequency receivers 38, which may be disposed in different directions. In embodiments, middle frequency receiver 38 may be rotated by a motor (not illustrated), which may allow middle frequency receiver 38 to sense signals in different directions. It should be noted that a plurality of middle frequency receivers 38 may be rotated by the motor. Sensor array 32 may emit acoustic waves and may further record reflected acoustic waves. Specifically, non-linear acoustic waves may be transmitted from sensor array 32, which may further record specific properties of non-linear acoustic waves which may be reflected from tubing 12, casing 14, and/or cement 22. Recorded non-linear acoustic waves may be used to identify characteristics of tubing 12, casing 14, and/or cement 22, referring to FIG. 1. Non-linear acoustic waves may further be transmitted, directed, and focused within a desired area. FIG. 3 illustrates graphically the phenomenological model of hysteresis in cement 22 with an instantaneous transition as pressure may be applied to cement 22 and the effects on stress and strength of cement 22. For example, a low frequency non-linear acoustic wave may press against tubing 12, casing 14, and/or cement 22. On a micro-level, this may cause movement within tubing 12, casing 14, and/or cement 22. Reflected non-linear acoustic waves from the movement of tubing 12, casing 14, and/or cement 22 may be analyzed for properties in tubing 12, casing 14, and/or cement 22.

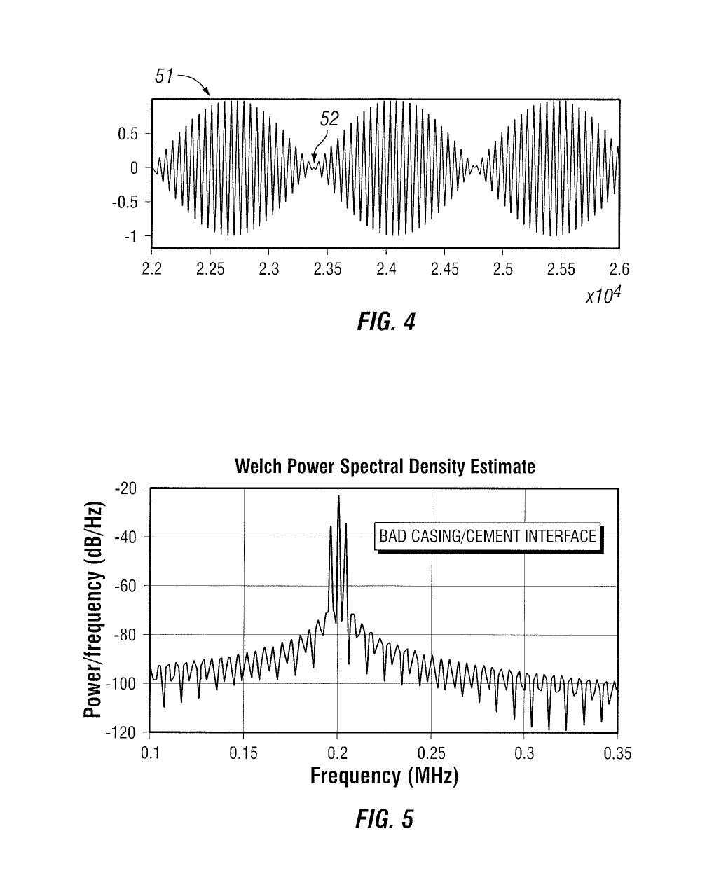

In embodiments, non-linear acoustic waves on the surface of tubing 12, casing 14, and/or cement 22 may be illustrated as an open state 57 or a closed state 52, as illustrated in FIG. 4. In an open state 51, a low frequency non-linear acoustic wave may be transmitted from sensor array 32, referring to FIG. 2. In the closed state 52, reflection of the non-linear acoustic signal from tubing 12, casing 14, cement 22, formation 24 may be recorded. The non-linear acoustic signal phenomena that may be recorded may be known as self-demodulation.

FIGS. 5-7 illustrate different self-demodulation recorded non-linear signals that may be used to determine properties of tubing 12, casing 14, and/or cement 22. Without limitation, FIGS. 5-7 may comprise both high and low frequency transmissions from sensor array 32. For example, frequencies transmitted may range from about 1 kHz to about 5 kHz and about 200 kHz. In embodiments, properties of casing 14, cement 22, and/or the interaction between casing 14 and/or cement 22 may be analyzed. Non-linear acoustic signals may be beneficial for an analyses of properties of casing 14, cement 22, and/or the interaction between casing 14 and/or cement 22. This may be due to non-linear acoustic signals, which may be sensitive to casing 14 and cement 22 interfaces, the density of cement 22, and/or cement 22 and formation 24 interface.

FIG. 5 illustrates a bad interface between casing 14 and cement 22. As illustrated in FIG. 5, a bad interface between casing 14 and cement 22 may generate frequency mixing. This may be due to the fact that non-linear acoustic waves may not be reflected back to sensor array 32, as voids between casing 14 and cement 22 may absorb and/or scatter non-linear acoustic waves. This may prevent reflection of non-linear acoustic waves and nonlinear-dissipative mechanism may dominate the recorded non-linear acoustic wave, which may displayed in a graph as illustrated in FIG. 5.

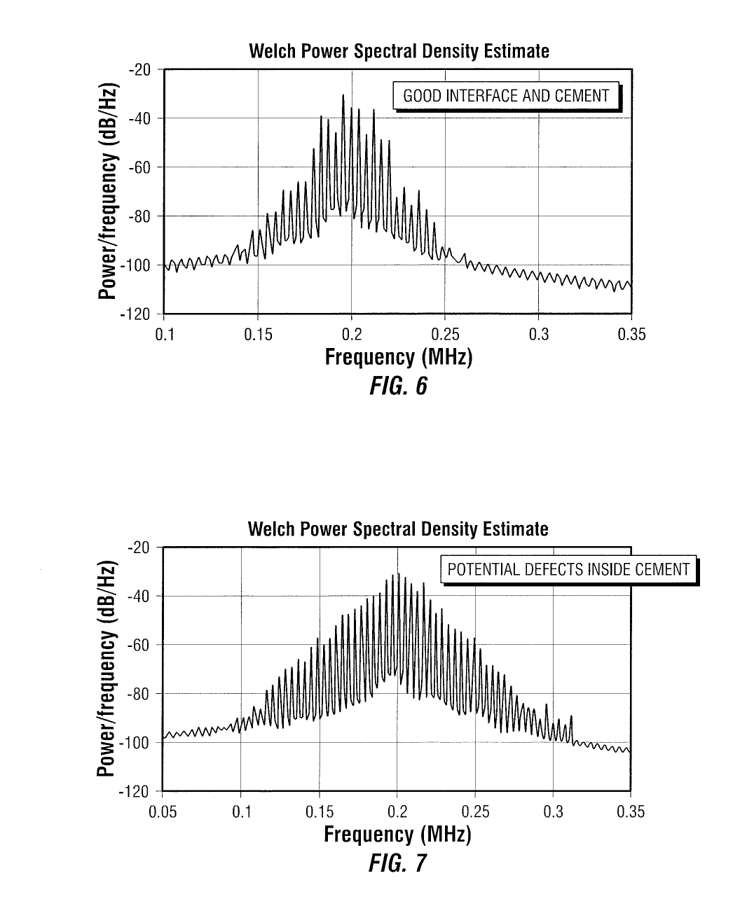

FIG. 6 illustrates a good interface between casing 14 and cement 22. As illustrated in FIG. 6, a good interface between casing 14 and cement 22 may reflect non-linear acoustic waves back toward sensor array 32 for recording. The recorded non-linear acoustic waves may be graphically displayed as illustrated in FIG. 6. FIG. 6 illustrates recorded non-linear acoustic waves.

FIG. 7 illustrates potential defects inside cement 22. As illustrated in FIG. 7, defects within cement 22 may reflect amplitude of reflected non-linear dissipative acoustic waves. In embodiments, voids in cement 22 may reflect larger amounts of low frequency acoustic waves back toward sensor array 32. The graph in FIG. 7 illustrates sensor array 32 in which large amounts of low frequency non-linear acoustic waves may be recorded.

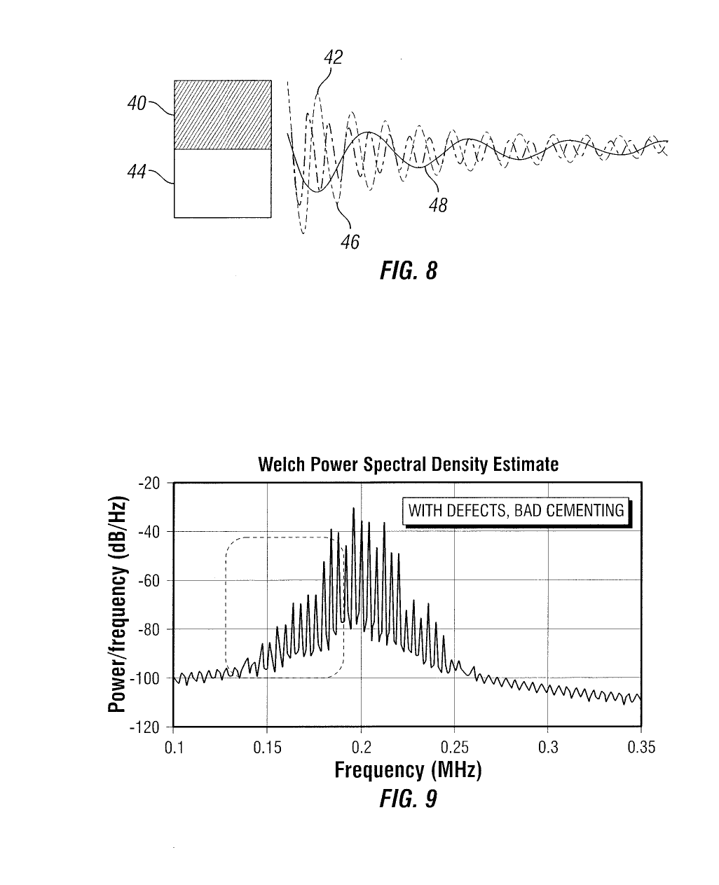

It should be noted that non-linear low frequency acoustic waves may be transmitted by low frequency transmitter 37 and/or by two high frequency transmitters 36. As illustrated in FIG. 8 a first high frequency transmitter 40 which may transmit a first high frequency non-linear acoustic wave 42. A second high frequency transmitter 44 may transmit a second high frequency non-linear acoustic wave 46. First high frequency non-linear acoustic wave 42 and second high frequency non-linear acoustic wave 46 may create low frequency non-linear acoustic wave 48 through destructive interference.

Recorded non-linear acoustic waves may be analyzed by information handling system 50 to determine properties of tubing 12, casing 14, and/or cement 22. Without limitation, information handling system 50 may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, information handling system 50 may be a personal computer, a network storage device, or any other suitable device and may vary in size, shape, performance, functionality, and price. Information handling system 50 may include random access memory (RAM), one or more processing resources such as a central processing unit (CPU) or hardware or software control logic, ROM, and/or other types of nonvolatile memory. Additional components of information handling system 50 may include one or more disk drives, one or more network ports for communication with external devices as well as various input and output (I/O) devices, such as a keyboard, a mouse, and a video display. Information handling system 50 may also include one or more buses operable to transmit communications between the various hardware components.

Certain examples of the present disclosure may be implemented at least in part with non-transitory computer-readable media. For the purposes of this disclosure, non-transitory computer-readable media may include any instrumentality or aggregation of instrumentalities that may retain data and/or instructions for a period of time. Non-transitory computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such as wires, optical fibers, microwaves, radio waves, and other electromagnetic and/or optical carriers; and/or any combination of the foregoing.

As illustrated in FIG. 9, filters may be applied to recorded non-linear acoustic waves. For example, a low pass filter, a bandpass filter or a narrow band filter may be utilized to analyze specific areas of recorded non-linear acoustic waves. Information handling system 50 may process information, in embodiments on the surface and/or downhole, referring to FIG. 1, to determine the location of a defects in cement 22 and/or the interface between cement 22 and tubing 12 or cement 22 and formation 24.

Although the present invention and its advantages have been described in detail, it should be understood that various changes, substitutions and alterations may be made herein without departing from the spirit and scope of the invention as defined by the appended claims.

1. A method for inspecting concrete downhole comprising:
inserting an inspection device inside a tube, wherein the inspection device comprises:
a sensor array comprising:
a high frequency transmitter;
a low frequency transmitter; and
a mid frequency receiver;
a micro controller unit;
a telemetry module; and
a centralizing module;
activating the low frequency transmitter, wherein the low frequency transmitter produces a non-linear wave;
recording reflections of acoustic waves off a tubing or a casing; and
creating a graph with an information handling system for analysis.

2. The method of claim 1, wherein recording reflections of acoustic waves comprises frequency mixing which is indicative of a bad interface between the tubing and the cement.

3. The method of claim 1, wherein recording reflections of acoustic waves comprises non-linear waves which is indicative of a good interface between the tubing and the cement.

4. The method of claim 1, wherein recording reflections of acoustic waves comprises non-linear dissipative performance which is indicative of a defect within the cement.

5. The method of claim 1, wherein recording reflections of acoustic waves comprises non-linear dissipative performance which is indicative of properties between the concrete and a second casing.

6. The method of claim 1, wherein a filter is applied to the graph to analyze a selected frequency.

7. The method of claim 5, wherein the filter is a low pass filter.

8. A method for inspecting concrete downhole comprising:
inserting an inspection device inside a tube, wherein the inspection device comprises:
a sensor array comprising:
a first high frequency transmitter;
a second high frequency transmitter; and
a mid frequency receiver;
a micro controller unit;
a telemetry module; and
a centralizing module;
activating the first high frequency transmitter and the second high frequency transmitter, wherein a non-linear wave is broadcasted by destructive interference from the first high frequency transmitter and the second high frequency transmitter;
recording reflections of acoustic waves off a tubing or a casing; and
creating a graph with an information handling system for analysis.

9. The method of claim 8, wherein recording reflections of acoustic waves comprises frequency mixing which is indicative of a bad interface between the tubing and the cement.

10. The method of claim 8, wherein recording reflections of acoustic waves comprises non-linear waves which is indicative of a good interface between the tubing and the cement.

11. The method of claim 8, wherein recording reflections of acoustic waves comprises non-linear dissipative performance which is indicative of a defect within the cement.

12. The method of claim 8, wherein a filter is applied to the graph to analyze a selected frequency.

13. The method of claim 12, wherein the filter is a low pass filter.

14. The method of claim 8, wherein the sensor array is disposed at about a bottom side of the inspection device.

15. An inspection device comprising:
a sensor array comprising:
a high frequency transmitter; and
a mid frequency receiver;
a sensor array housing, wherein the sensor array is disposed within the sensor array housing;
an information handling system;
a memory module; and
a differential amplifier.

16. The inspection device of claim 15, wherein the sensor array is disposed at about a bottom side of the inspection device.

17. The inspection device of claim 15, wherein the sensor array further comprises a low frequency transmitter.

18. The inspection device of claim 15, wherein the sensor array further comprises a second high frequency transmitter.

19. The inspection device of claim 15, wherein the high frequency transmitter is rotated by a motor.

20. The inspection device of claim 15, wherein the information handling system is disposed on the inspection device or on a surface.
